(19) United States
(12) Patent Application Publication
(10) Pub. No.: US 2005/0278261 A1
(43) Pub. Date: Dec. 15, 2005

(54) Navigational controls for a presentation system

(76) Inventors: Richard Omanson, Naperville, IL (US); Robert Schumacher, Wheaton, IL (US); Michael Murphy, Bethlehem, PA (US); Frank Germano, Westford, MA (US); Jill Wene Cheeks, Ashville, NC (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 11/026,689

(22) Filed: Dec. 31, 2004

Related U.S. Application Data
(60) Provisional application No. 60/579,343, filed on Jun. 14, 2004.

(51) Int. Cl. G06F 17/60

(52) U.S. Cl. 705/77; 705/1; 705/30; 705/53; 705/34; 705/40

(57) ABSTRACT

Embodiments of the present disclosure provide systems and methods for implementing navigational controls for presenting data, such as call-center data. Briefly described, in architecture, one embodiment of the system, among others, can be implemented as follows. An application interface that accesses a plurality of computer applications is provided, where at least one computer application is located on a computer network. The system further includes a set of application controls associated with the application interface. In particular, each application control is associated with a particular computer application. In addition, the system includes at least one navigational control associated with at least one application control. Accordingly, a respective navigational control activates a particular screen of information from the particular computer application, such that the particular screen of information is displayed on a computer display and shows data related to a current user-session. Other systems and methods are also provided.

### CROSS-REFERENCE TO RELATED APPLICATION

This application claims priority to U.S. provisional application entitled, “Presentation System,” having Ser. No. 60/579,343, filed Jun. 14, 2004, which is entirely incorporated herein by reference.

This application is related to copending U.S. utility patent application entitled “Frameless Presentation System” filed on the same date as the present application and accorded Ser. No. ______, which is entirely incorporated herein by reference; U.S. utility patent application entitled “Multiple Application Viewing” filed on the same date as the present application and accorded Ser. No. ______, which is entirely incorporated herein by reference; U.S. utility patent application entitled “Organizing Session Application” filed on the same date as the present application and accorded Ser. No. ______, which is entirely incorporated herein by reference; U.S. utility patent application entitled “Viewing Applications from Inactive Sessions” filed on the same date as the present application and accorded Ser. No. ______ which is entirely incorporated herein by reference; U.S. utility patent application entitled “Floating User Interface” filed on the same date as the present application and accorded Ser. No. ______, which is entirely incorporated herein by reference; U.S. utility patent application entitled “Tracking User Operations” filed on the same date as the present application and accorded Ser. No. ______, which is entirely incorporated herein by reference; and U.S. utility patent application entitled “Administration Manager” filed on the same date as the present application and accorded Ser. No. ______, which is entirely incorporated herein by reference.

### TECHNICAL FIELD

The present disclosure is generally related to computer systems and, more particularly, is related to presenting data from computer applications.

### BACKGROUND

Many desktop presentation systems, such as those in use within call center environments, pose significant challenges in user productivity. For example, multiple user interface technologies, desktops, and metaphors are pervasive within today's call center environments, including for example, web browsers, X/Motif emulators, TN3270, and PC-based graphical user interfaces (GUIs). Accordingly, a user in an environment, such as a call center, that often has to employ a variety of different applications on a computer desktop at the same time, can have difficulty managing, organizing, and operating effectively. For example, a user may have to repeatedly access a particular screen of an application located on a mainframe computer for different users or transactions. Therefore, it would be useful to have an efficient manner for accessing the particular screen for different customers or transactions.

Thus, a heretofore unaddressed need exists in the industry to address the aforementioned deficiencies and inadequacies.

### SUMMARY

Embodiments of the present disclosure provide systems and methods for implementing navigational controls for presenting data, such as call-center data. Briefly described, in architecture, one embodiment of the system, among others, can be implemented as follows. An application interface that accesses a plurality of computer applications is provided, where at least one computer application is located on a computer network. The system further includes a set of application controls associated with the application interface. In particular, each application control is associated with a particular computer application. In addition, the system includes at least one navigational control associated with at least one application control. Accordingly, a respective navigational control activates a particular screen of information from the particular computer application, such that the particular screen of information is displayed on a computer display and shows data related to a current user-session.

Embodiment of the present disclosure can also be viewed as providing methods for implementing navigational controls for presenting data, such as call-center data. In this regard, one embodiment of such a method, among others, can be broadly summarized by the following steps: establishing an area on the computer display in which at least one selectable navigational control is to be displayed, the at least one selectable navigational control associated with a particular computer application hosted on a mainframe computer; selecting the at least one selectable navigational display; and displaying a representation of the particular screen of information from the computer application hosted on the mainframe computer—the particular screen of information showing data related to a current user-session. In some embodiments, among others, the selectable navigational control is presented as a button on an application bar or a selectable option in a menu box.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of one embodiment, among others, of a presentation system of the present disclosure.

FIG. 2 is block diagram of one embodiment, among others, of an application bar of a navigation manager of the presentation system of FIG. 1.

FIGS. 3-8 are block diagrams of several embodiments, among others, of a desktop arrangement of the presentation system of FIG. 1.

FIG. 9 is a screenshot diagram of one embodiment, among others, of desktop arrangement of the presentation system of FIG. 1.

FIG. 10 is a flowchart describing the functionality of one embodiment, among others, of the presentation system of FIG. 1.

### DETAILED DESCRIPTION

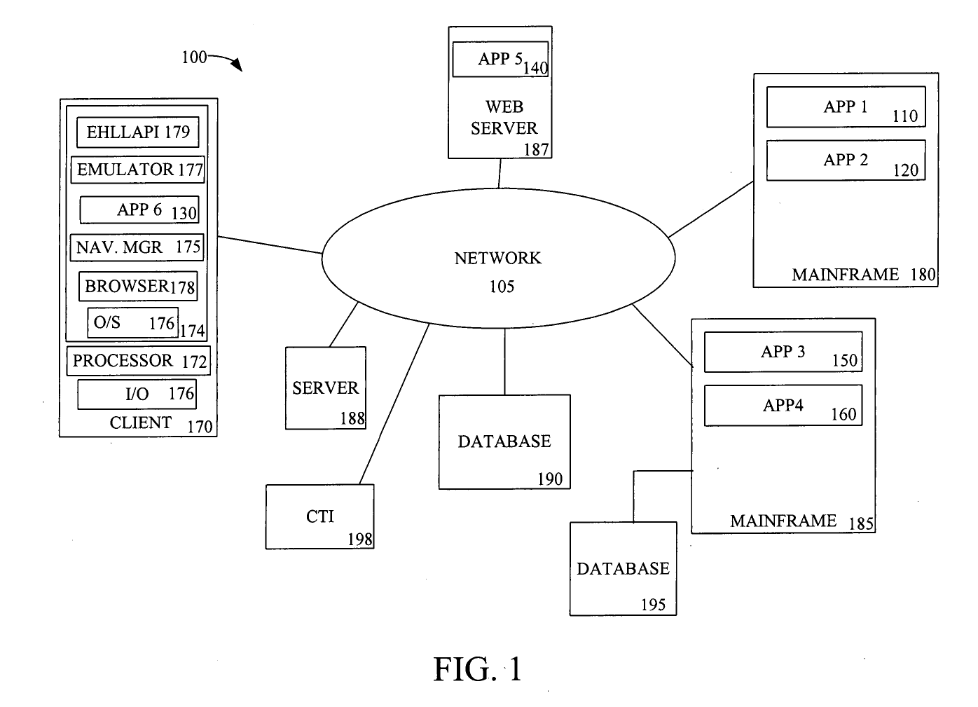

FIG. 1 shows one embodiment of a presentation system 100 for providing navigational controls to particular navigational points within a plurality of computer applications 110-160. The presentation system 100 in FIG. 1 comprises a general-purpose computer 170 connected to a computer network 105, such as the Internet, Intranet, local area network (LAN), wide area network (WAN), etc. Also connected to the computer network 105 are other computing devices, such as mainframe computers 180-185, servers 187-188, and network databases 190-195 that contain computer applications and data. A variety of computer applications 110-160 may be accessed by a user logged on to the computer network 105. For example, computer applications may be installed on the mainframe computers 180-185; and web-based applications 140 may be installed on the servers 187-188. Further, data accessed by these applications may be stored on the databases 190-195.

Typically in a business enterprise, mainframe computers 180-185 execute a variety of line of business (LOB) applications which may include older computer systems that are critical to the operation of the enterprise and are generally referred to as legacy systems 110-120, 150-160. To access legacy systems or applications 110-120, 150-160 on a mainframe computer or host 180-185, a terminal (e.g. IBM 3270) with little processing capacity was traditionally utilized, since most of the processing took place at the host or mainframe computer. The host transmitted formatted screens of character-based data to the terminal that were displayed on the terminal screen. Each “green screen” had to be individually requested from the host, and therefore, it might take several seconds to transition from screen to screen. In addition, a user may need to log out of a session of one legacy application 110 so that the user could access a screen of another legacy application 120, 150-160. A session generally refers to an association of applications or application instances according to a common customer or transaction. Unlike general-purpose computers of today, a user cannot jump from program to program in a legacy system or use the operating system to transfer data from one program to another. Such terminals are now out-dated.

Because the logic required to run legacy systems reflects a significant investment, owners of these legacy systems are understandably reluctant to discard them. However, these systems run on obsolete hardware and software and may no longer be maintainable or expandable. One possible solution is to install a software terminal emulator 177 in the general-purpose computer 170 which enables it to operate as though it were a character-based terminal. With the emulator installed, the general-purpose computer 177 looks like a standard terminal to the host 180-185.

As shown, the general-purpose computer 170 includes a variety of applications that also loaded into memory 174 of the general-purpose computer 170. Generally, in terms of hardware architecture, as shown in FIG. 1, the computer 170 includes a processor 172, memory 174, and one or more input and/or output (I/O) devices 176 (or peripherals) that are communicatively coupled via a local interface (not shown). The local interface can be, for example but not limited to, one or more buses or other wired or wireless connections as those skilled in the art would appreciate. The local interface may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 172 is a hardware device for executing software, particularly that stored in memory 174. The processor 172 can be any custom made or commercially available processor, a central processing unit (CPU), an auxiliary processor among several processors associated with the computer 170, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company®, an 80×86 or Pentium® series microprocessor from Intel Corporation®, a PowerPC® microprocessor from IBM®, a Sparc® microprocessor from Sun Microsystems, Inc®, or a 68xxx series microprocessor from Motorola Corporation®.

The memory 174 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 174 may incorporate electronic, magnetic, optical, and/or other types of storage media. Note that the memory 174 can have a distributed architecture, where various components are situated remote from one another, but can be accessed by the processor 172.

The software in memory 174 may include one or more separate programs, each of which comprises an ordered listing of executable instructions for implementing logical functions. In the example of FIG. 1, the software in the memory 174 includes a navigation manager 175 in accordance with the present disclosure; a suitable operating system (O/S) 176; terminal emulator 177; a web browser application 178; Emulator High Level Language Applications Programming Interface (EHLLAPI) 179; and other local applications 130 (e.g., thin clients, fat clients, LOB applications; etc.). A nonexhaustive list of examples of suitable commercially available operating systems 176 is as follows: (a) a Windows® operating system available from Microsoft Corporation®; (b) a Netware® operating system available from Novell, Inc.®; (c) a Macintosh® operating system available from Apple Computer, Inc®; (d) a UNIX® operating system, which is available for purchase from many vendors, such as the Hewlett-Packard Company®, Sun Microsystems, Inc.®, and AT&T Corporation®; (e) a LINUX® operating system, which is freeware that is readily available on the Internet; (f) a run time Vxworks® operating system from WindRiver Systems, Inc.®; or (g) an appliance-based operating system, such as that implemented in handheld computers or personal data assistants (PDAs) (e.g., PalmOS® available from Palm Computing, Inc.®, and Windows CE® available from Microsoft Corporation®. The operating system 176 controls the execution of other computer programs, such as the navigation manager 175, and provides scheduling, input-output control, file and data management, memory management, and communication control and related services.

According to an exemplary embodiment, the navigation manager 175 is a source program, executable program (object code), script, or any other entity comprising a set of instructions to be performed. When a source program, then the program needs to be translated via a compiler, assembler, interpreter, or the like, which may or may not be included within the memory 174, so as to operate properly in connection with the O/S 176. Furthermore, the navigation manager 175 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices 176 may include input devices, for example but not limited to, a keyboard, mouse, scanner, microphone, etc. Furthermore, the I/O devices 176 may also include output devices, for example but not limited to, a printer, display, etc. Finally, the I/O devices 176 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer 170 is a PC, workstation, or the like, the software in the memory 174 may further include a basic input output system (BIOS) (omitted for simplicity). The BIOS is a set of software routines that initialize and test hardware at startup, start the O/S 176, and support the transfer of data among the hardware devices. The BIOS is stored in ROM so that the BIOS can be executed when the computer 170 is activated.

When the computer 170 is in operation, the processor 172 is configured to execute software stored within the memory 174, to communicate data to and from the memory 174, and to generally control operations of the computer 170 pursuant to the software. The navigation manager 175, the O/S 176, and other local applications, in whole or in part, but typically the latter, are read by the processor 172, perhaps buffered within the processor 172, and then executed.

Referring back to FIG. 1, the navigation manager 175 included in the general-purpose computer 170 manages the displaying of multiple computer applications 110-160, including legacy applications 110-120, 150-160 located on mainframe computers 180-185. The navigation manager 175, in some embodiments, comprises a user interface that is represented in a visual form of an application bar (e.g., a toolbar) on a desktop of the general-purpose computer 170. Generally, an application bar is a Windows control that allows a user to perform some actions by clicking a button located on the application bar. An application bar often simplifies a user's job by bringing the most accessible actions as buttons that can be directly accessed by the user.

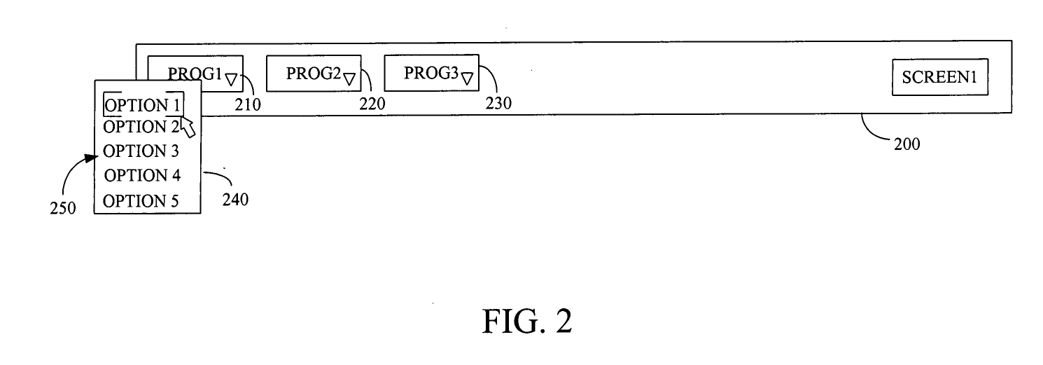

Generally, the navigation manager 175 manages the presentation of data on the desktop of the general-purpose computer 170 or another display from other computer applications. FIG. 2 shows one embodiment 200 of the application bar of the navigation manager 175. In FIG. 2, the application bar 200 includes several navigational buttons 210-230 that correspond to different computer application that can be accessed by the navigation manager 175. In particular, the application bar 200 shows navigation buttons 210-230 for an application titled “PROG1” 210; an application titled “PROG2” 220; and an application titled “PROG3” 230. Each of these buttons refers to different application programs (e.g., legacy applications 110 120, 150-160, web-based applications 140, local applications 130, fat applications, thin clients, etc.) that can be accessed by and displayed to a user of the general-purpose computer 170.

In a typical call-center environment, for example, PROG1 210 may refer to a Siebel® application that is stored locally on the general-purpose computer. Generally, the Siebel® application allows a user (e.g., a call-center agent) to view customer-specific promotions; to view and perform customer follow-ups; and to locate customer records. PROG2 may refer to a Business Office Customer Record Inquiry System (BOCRIS) application that is stored on a mainframe computer 180-185. Generally, the BOCRIS application allows a user to view detailed billing information including screens directed toward local service itemization (LSI), billing, customer service reports (CSR), pending orders, etc. PROG3 may refer to a web-based application that access a web-server and related databases, for example.

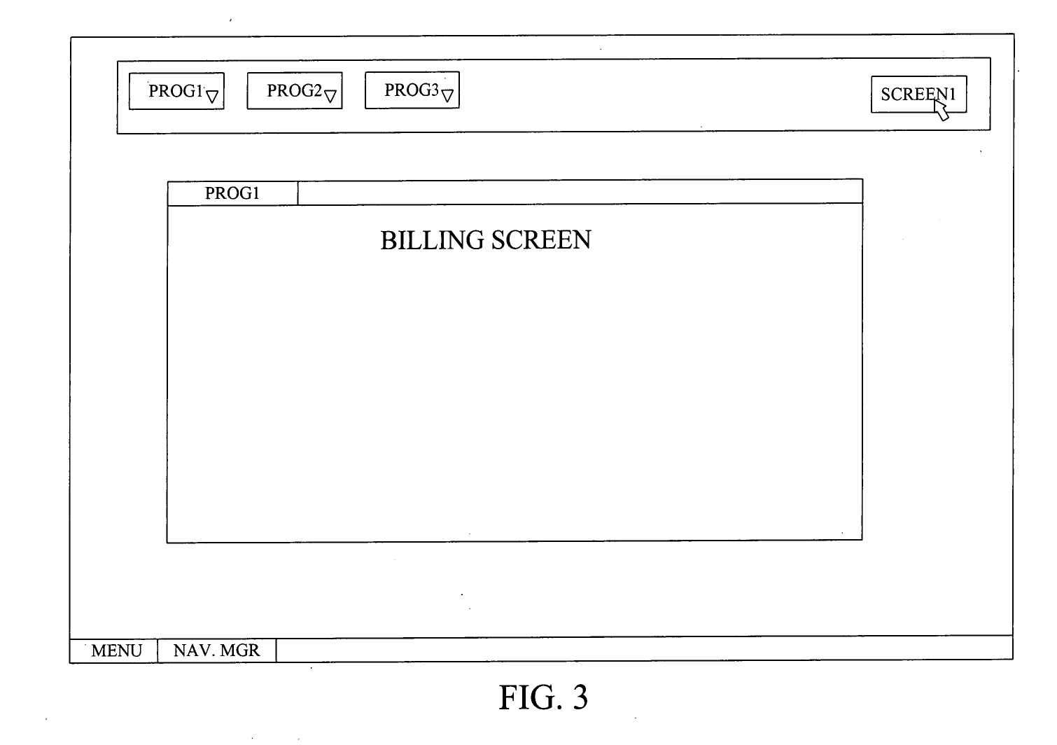

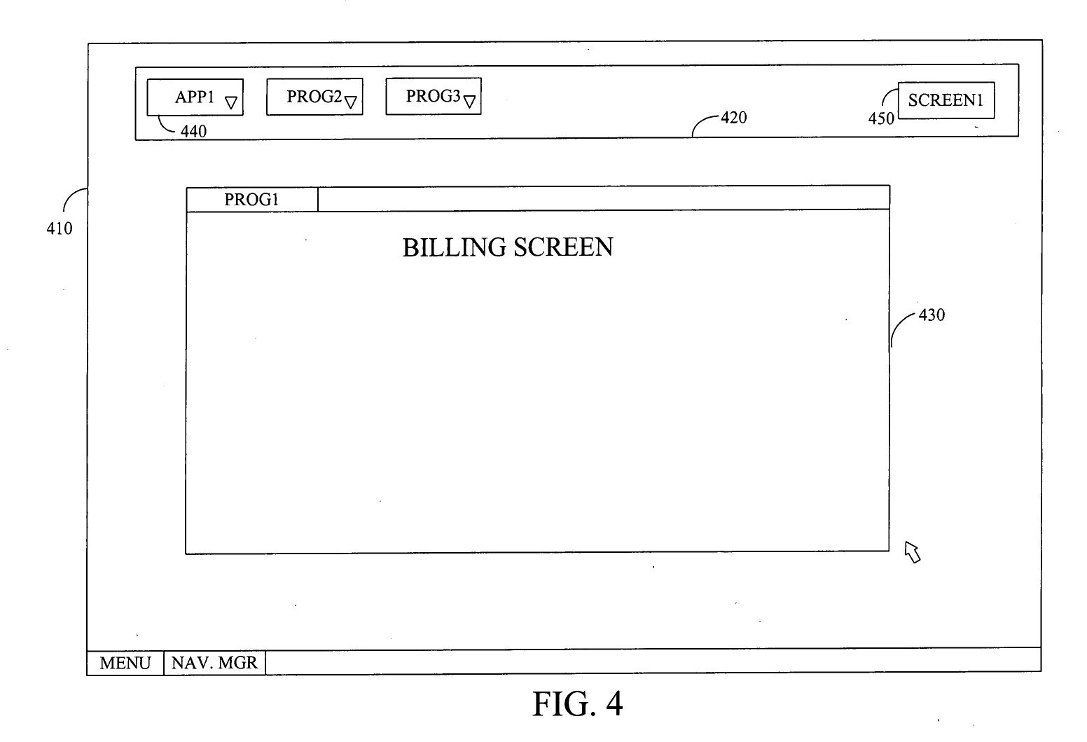

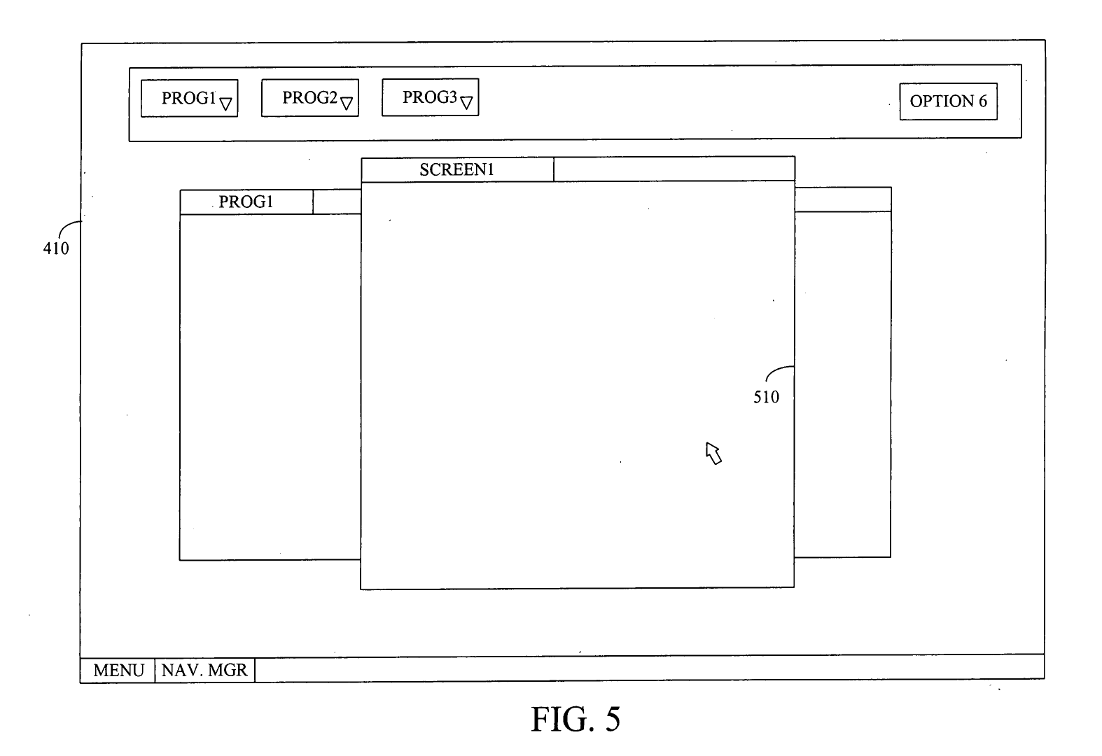

The application bar 200 may further include additional navigational controls 240 that are displayed after a user selects or “clicks” on a navigational button 210-230 corresponding to a computer application. For example, a user can click on the navigational button 210 for “PROG1” which in turn displays a drop-down list 240 of particular screens or navigational points within the respective computer application (e.g., PROG1), as shown in FIG. 2. For a BOCRIS application, for example, a user may be able to select from the drop-down list or menu 240, a variety of navigational points 250 including a main entry screen (e.g., Option 1), a billing screen (e.g., Option 2), pending orders screen (e.g., Option 3); customer service record (e.g., Option 4); etc. Via the navigational controls 250 in the application bar 200, a user can directly access desired informational data without having to navigate across undesired screens or pages of informational data from a particular application 110-160. Accordingly, a user can jump from the 5^{th} screen (e.g., a Billing Screen) of a BOCRIS application (as shown in FIG. 3) and directly access the 3^{rd} screen (e.g., Product Offers) of some other application (as shown in FIGS. 4-5).

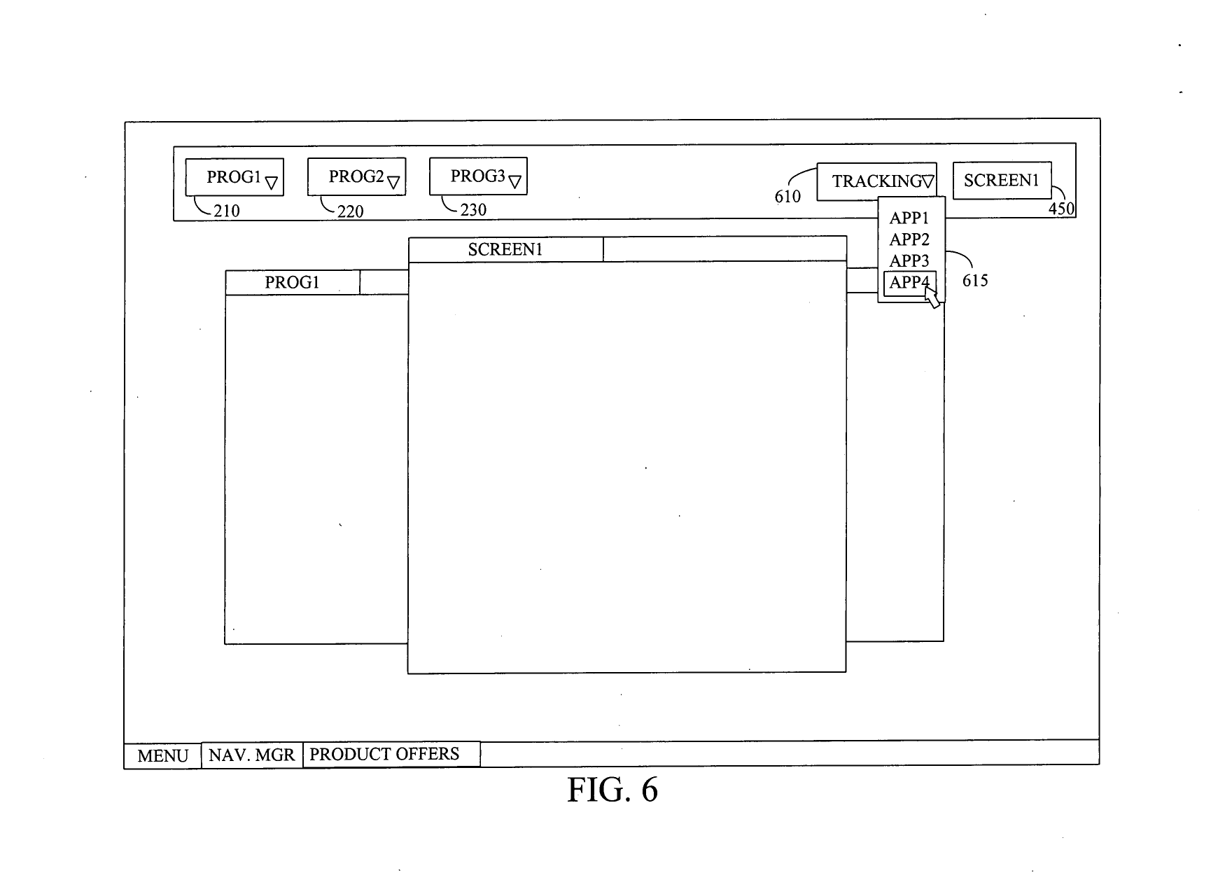

In particular, FIG. 4 shows a computer screen 410 displaying an application bar 420 and a rendering 430 of a billing screen of a BOCRIS (PROG1) application. The BOCRIS rendering 430 was launched by activating the PROG1 button 440 on the application bar. As previously explained, the displayed billing screen is assumed to be the 5^{th} screen that a user would typically encounter in a BOCRIS application. In the described embodiment of FIG. 4, however, a user can immediately access the billing screen 430 by selecting the PROG1 button 440. Accordingly, to directly access another screen of another application, a user can select a different button on the application bar 420. For example, assume that the Screen1 button 450 is associated with a different application system (whether a legacy system, locally stored system, web-based system, etc.) By selecting the Screen1 button 450, one embodiment of the presentation system displays a particular screen of the application system associated with the Screen1 button 450, as shown in FIG. 5. Here, a Product Offers screen or display 510 is shown to the user on the computer screen 410. In this particular example, a button on the application bar can be configured to display a particular screen of information without the additional steps of selecting an option from a drop-down menu. Accordingly, one embodiment of the application bar 200 may provide a multitude of navigation controls 210, 220, 230, 450, 610, 615 for accessing particular points within a variety of computer applications 110-160, as shown in FIG. 6. Further, in some embodiments, the rendering 430 of a legacy application is provided in a “green screen” format.

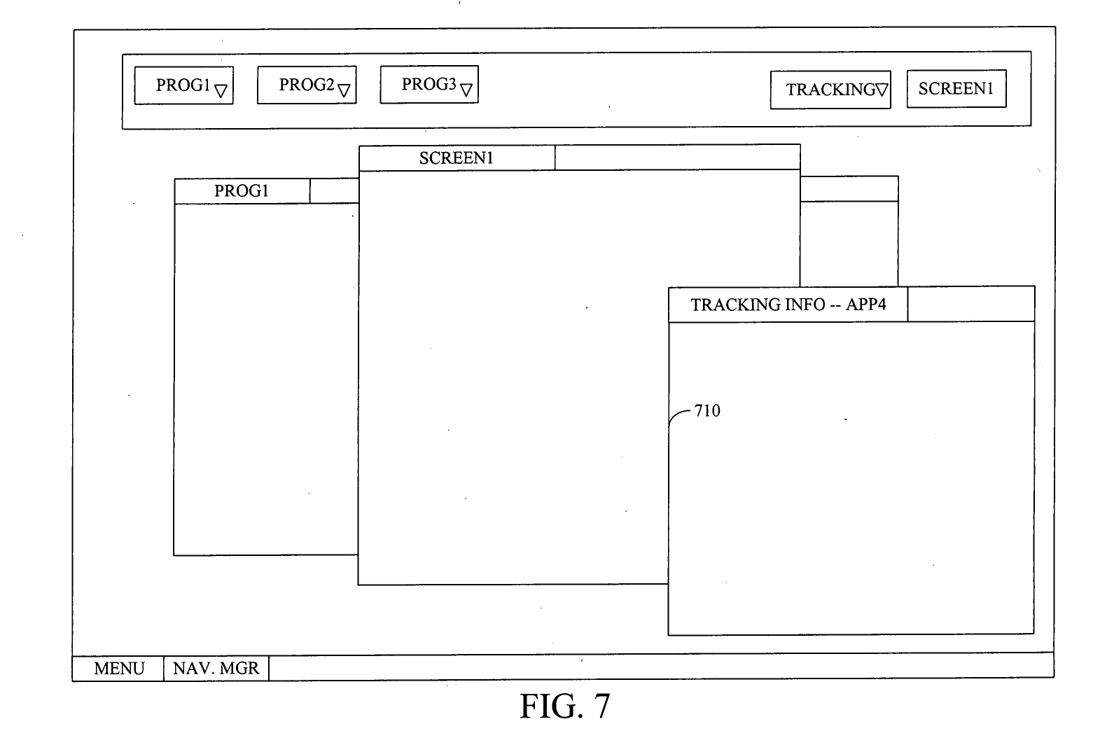

In addition to the navigation controls 210, 220, 230, 450 that have been previously discussed, one embodiment of the navigation manager may also provide a navigation control 610 that allows a drop-down list 615 to provide common screens of different applications. For example, many different computer applications may provide a tracking screen for recording a history of past transactions or events for the respective computer application. Therefore, direct access to tracking screens for different computer applications may be provided by a single navigational control 610. For example, by selecting the APP4 option in the drop-down list box 615, a screen 710 showing tracking information from APP4 can be directly accessed, in some embodiments, as shown by FIG. 7.

A variety of mechanisms for facilitating such navigational controls may be employed and utilization of which may depend partly on the types of computer applications 110-160 being accessed by the general-purpose computer 170. For example, for computer applications 110-120, 150-160 hosted on mainframe computers 180-185, some embodiments of the navigation manager 175 communicates directly with the legacy application 110-120, 150-60 via an Emulator High Level Language Applications Programming Interface (EHLLAPI) 179, in some embodiments. Therefore, when the user selects a particular navigational control 210-250, the navigation manager 175 provides the EHLAPPI with a command to access the corresponding screen associated with the particular navigational control 210-250. The EHLAPPI further translates the received command into the appropriate command within the native language of the legacy application 110-120, 150-160 along with the necessary data that is needed to retrieve the desired screen (that is passed to the EHLAPPI by the navigation manager 175).

For other types of computer applications such as a local LOB application 130 stored on the general-purpose computer 170, different techniques for accessing selected screens may be employed. For example, for a Siebel Call Center® application that is stored locally on a general-purpose computer (e.g., a fat client version of a Siebel Call Center application), commands may be provided to the Siebel® application along with the necessary data to receive the desired screen information that can be displayed to a user, for some embodiments. Therefore, different functional navigation points can be provided on the application bar 200 for different applications as a management tool for controlling the manner that data is presented to a user. As such, applications can be defined in terms of functionality instead of particular application titles or screens. For example, a functional navigation point entitled “GO TO BILLING” is provided for any application title or any application screen as defined by the presentation system 100, for some embodiments.

Further, in some embodiments, the navigation manager 175 comprises a .NET client that is deployed on a desktop of the general-purpose computer 170. The NET client manages hosted application interaction. A hosted application accordingly is client-side interface to a back-end application through which to interact with a LOB application or system 110-160. If the back-end application is a client/server application running on a Windows operating system 176, then the hosted application could be an existing client-side interface. If the back-end application is a legacy system 110-120, 150-160 running on a mainframe computer 180-185, the hosted application in the AIF could be an emulation application 177 that passes data to the legacy system or a web browser application that passes data to a web service that communicates with the legacy system 110-120, 150-160.

Hosted applications or clients may comprise a variety of technologies, such as Straight HTML; COM/ActiveX; NET Client and integrations with other local applications 130 such as Standalone .EXEs exposing APIs; Scriptable applications, such as JavaScript, VB Script, MS Excel, etc. Accordingly, for some embodiments, a web server 187 on the network 105 includes Internet Information Servers (IIS) with ASP.NET components that performs transactions as web services. Database(s) 190 typically may include SQL Server 2000 Enterprise architecture.

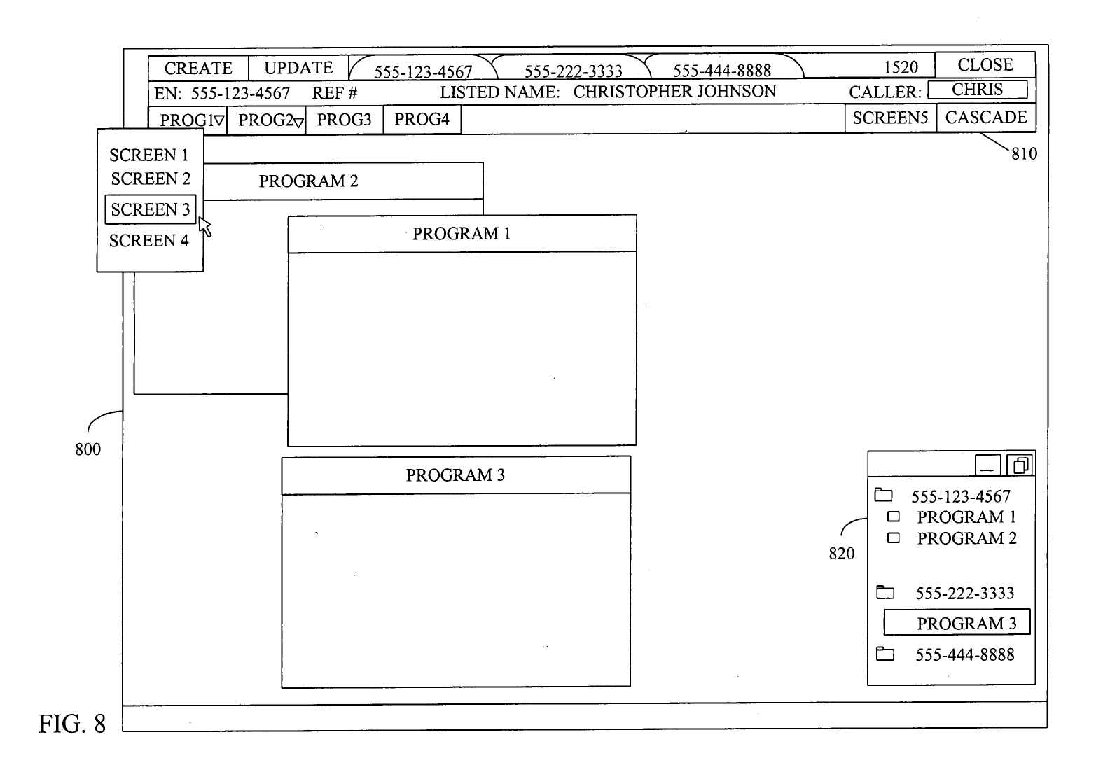

FIG. 8 shows one embodiment of a desktop arrangement of a general-purpose computer 170 in the presentation system 100. As shown in FIG. 8, a desktop 800 is presented with an application bar interface 810. The application bar 810 is a user interface to the navigation manager 175. In the embodiment shown, a user has accessed Program 2 (PROG2), Program 3 (PROG3), and Program 1 (PROG1).

For hosted applications on a mainframe, for example, the navigation manager 175 displays data from a respective hosted application in a graphical window control that is a “green screen” representation of the respective hosted application. The particular graphical window control is assigned a globally unique identifier (GUID) that is associated with the application bar 810 and not to the hosted application. The hosted application is typically not registered and executed as a separate application with the operating system of a general-purpose computer 170 of the user. For local applications, the local application 130 may be registered and executed as a separate application apart from the navigation manager 175 application with the operating system 176. However, both the local applications and the hosted applications will appear in similar manners with respect to the application bar 810 on the desktop 800. In this way, the presentation system 100 can leverage existing clients or existing vertical applications. For some embodiments, to aid in usability, a session navigator interface 820 is provided as part of the navigation manager 175 for some embodiments.

Additionally, in some embodiments, the NET client of the navigation manager 175 utilizes a Microsoft® Contact Center Framework application (CCF). Using technologies, such as XML web services, SOAP, BizTalk Server 2000, and Microsoft® Host Integration Server, the navigation manager 175 (via the Microsoft® Contact Center Framework) communicates with LOB systems 110-160. To enable interaction with back end systems, the CCF includes a component called the Application Integration Framework (AIF) which runs on Windows operating systems 176. The .NET framework-based AIF includes an Application Host component which is a set of COM objects that coordinates the interaction between hosted applications.

For some embodiments, a RUMBA® 3270 Emulator, which hosts legacy systems, such as the Business Office Customer Record Inquiry System (BOCRIS), exposes an ActiveX interface that can be integrated into the NET client. The AIF also includes an Application Integration Services component. The Application Integration Services component stores contextual information (e.g., a customer's name, address, current service information, etc.) that can be shared among hosted applications. Therefore, one advantage for embodiments of the presentation system 100 of the present disclosure is that the presentation system 100 allows data to be shared between different applications. For example, Siebel® can pass customer information to BOCRIS, for example.

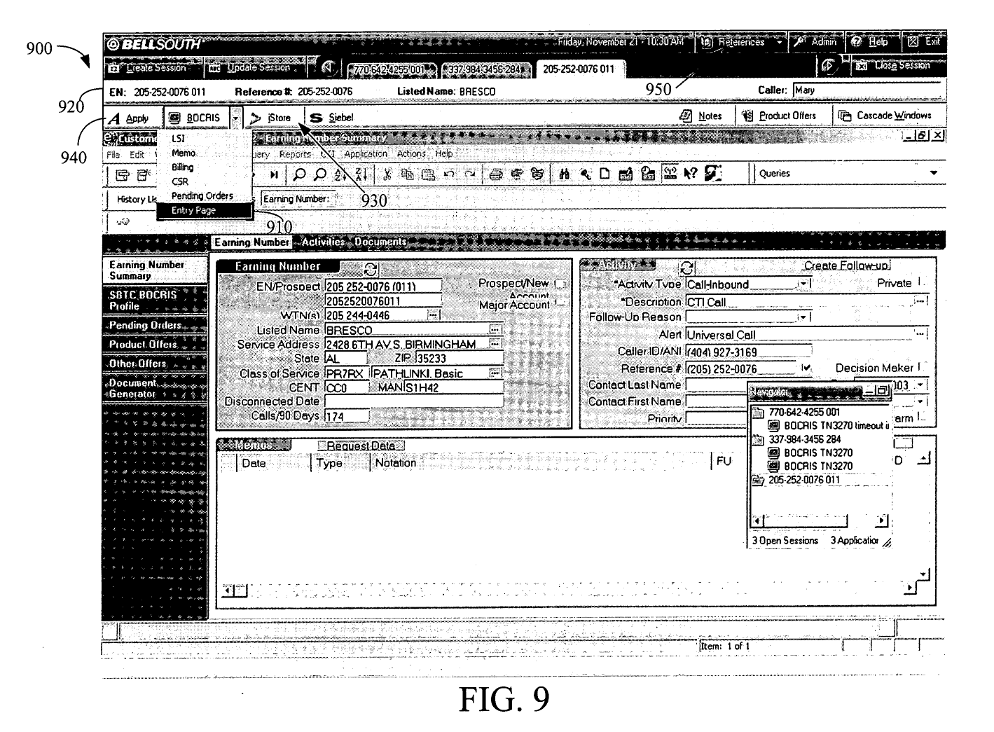

Next, FIG. 9 displays a screenshot 900 of a desktop arrangement for one embodiment of the presentation system 100. As shown in FIG. 9, a user for some applications is able to select a drop-down graphical menu 910 from the application bar interface 920 for a particular application. Here, a user has selected a drop-down menu for a BOCRIS application. Within the drop-down menu 910, a user can then select a particular screen to directly access from the BOCRIS application. For example, the user has selected an “Entry Page” screen. Accordingly, a user can use graphical user interface controls to jump to particular points within applications accessed within the presentation system 100. As shown, under a single presentation bar application, graphical autonavigation controls 910 to multiple applications (of legacy systems, for example) are provided.

For some embodiments involving a call-center environment, an iStore web application 930 (or similar application) for processing digital subscriber line (DSL) service orders is integrated into the NET client of the navigation manager 175. In particular, the iStore web application enables DSL Loop Qualification & Order Placement for a call-center environment. The hosted web appplication class provided in the NET client hosts the iStore web application 930. The hosted web application class is also extended to provide any additional functionality specific to the iStore application 930. In particular, Single Sign-On support is implemented in an extended hosted web application class.

Also, an Apply web application 940 (or similar application) for processing wireless telecommunication services is integrated into the NET client of the navigation manager 175, for some embodiments involving call-center environments. The Apply web application 940 allows a user to view promotions and eligibility information related to telephone services in the call-center environment; place service orders; and checks customer credit information. The hosted web application class provided in the NET client hosts the Apply web application 940. The hosted web application class is extended to provide any additional functionality specific to the Apply application 940. An Orbit web application (or similar application) is also integrated into the NET client as a link from a drop-down menu in the References button 950 for some embodiments involving call-center environments. The link launches an Orbit web application for researching product information, but does not typically provide any additional integration. Therefore, disparate technologies and applications may be interface using the presentation system 100 as described in the present disclosure. Although many of the embodiments discussed herein involved call-center environments, the present disclosure is not limited to call-center environments. Other lines of business applications such as those in banking, accounting, etc. are also contemplated.

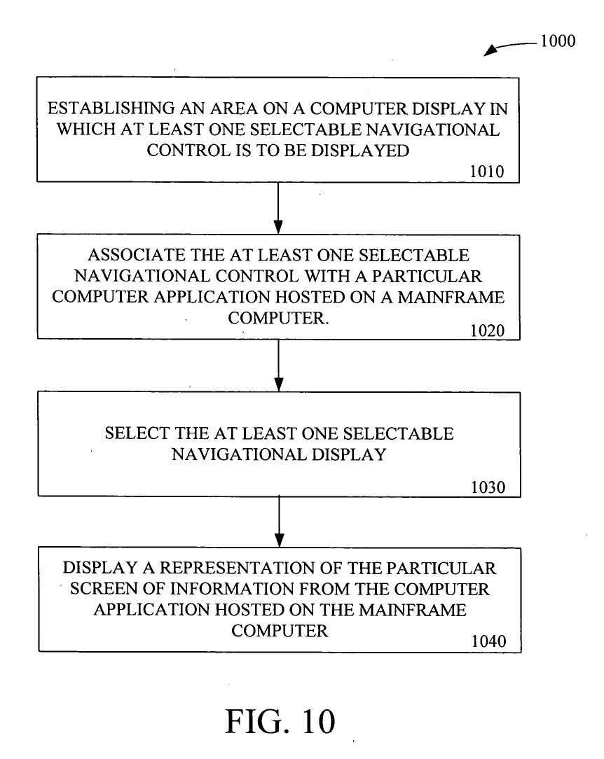

Therefore, as shown by FIGS. 1-9, embodiments of the presentation system 100 provide graphical controls for directly accessing desired content of legacy applications and other computer and network applications and services. The flowcharts of FIG. 10 shows the functionality of a representative implementation of the presentation system 100 of the present disclosure. As depicted in FIG. 10, the functionality of a representative embodiment of the presentation system 100 or method 1000 may be construed as beginning at the step of establishing (1010) an area on a computer display in which at least one selectable navigational control is to be displayed. The at least one selectable navigational control is associated (1020) with a particular computer application that is hosted, e.g., on a mainframe computer. By selecting (1030) the at least one selectable navigational display, a representation of the particular screen of information from the computer application hosted on the mainframe computer is displayed (1040). For some embodiments, the selectable navigational control is presented as a button on an application bar or a selectable option in a menu box.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure.

1. A system for implementing navigational controls for presenting data, comprising:
an application interface that accesses a plurality of computer applications, wherein at least one computer application is located on a computer network;
a set of application controls associated with the application interface, wherein each application control is associated with a particular computer application;
at least one navigational control associated with at least one application control, wherein a respective navigational control activates a particular screen of information from the particular computer application to be displayed on a computer display; and
logic configured to associate a plurality of activated screens of information with a user-session, the user-session associated with a particular task being performed by a user, wherein an activated screen of information of a particular user-session automatically displays data related to the particular user-session.

2. The system of claim 1, wherein the system presents call center data, and the computer applications are call center applications.

3. The system of claim 1, wherein at least one of the plurality of computer applications is a legacy application located on a mainframe computer on the computer network.

4. The system of claim 1, wherein application interface comprises a toolbar interface.

5. The system of claim 1, wherein the at least one navigational control is visually displayed in a drop-down menu that is activated by selecting an associated application control.

6. The system of claim 5, further comprising:
an emulator interface for translating commands from the navigational control into native commands for the particular computer application.

7. The system of claim 1, wherein the data related to the particular user-session current session comprises account information for a current customer being serviced by the user.

8. The system of claim 7, further comprising:
a sub-level window for displaying the particular screen of information under the application interface.

9. The system of claim 8, wherein at least one navigation control comprises a first navigational control to activate the displaying of a middle screen of information from a first legacy application.

10. A method for implementing navigational controls for presenting data, comprising the steps of:
establishing an area on a computer display in which at least one selectable navigational control is to be displayed, the at least one selectable navigational control associated with a particular computer application hosted on a mainframe computer;
selecting the at least one selectable navigational control;
displaying a representation of a particular screen of information from the particular computer application hosted on the mainframe computer, wherein the particular screen of information is associated with a selected navigational control, and the particular screen of information shows current session information; and
associating the representation of a particular screen of information with a user-session, the user-session identified with a particular task being performed by a user, wherein the particular screen of information of a particular user-session automatically displays data related to the particular user-session.

11. The method of claim 10, wherein the method presents call center data, and the particular computer application is a call center application.

12. The method of claim 10, wherein the particular screen of information is a middle screen of information.

13. The method of claim 10, wherein the at least one selectable navigational control is presented as a button on an application bar.

14. The method of claim 10, wherein the at least one selectable navigational control is presented as a selectable option in a menu box.

15. The method of claim 14, wherein the menu box is organized by subject matter.

16. The method of claim 14, wherein the menu box is associated with a single computer application.

17. The method of claim 10, wherein the particular screen of information is represented in a green-screen format.

18. A computer readable medium having a program for implementing navigational controls for presenting data, the program comprising the steps of:
establishing an area on a computer display in which at least one selectable navigational control is to be displayed, the at least one selectable navigational control associated with a particular computer application hosted on a mainframe computer;
selecting the at least one selectable navigational control;
displaying a representation of a particular screen of information from the particular computer application hosted on the mainframe computer, wherein the particular screen of information is associated with a selected navigational control, and the particular screen of information shows current session information; and
associating the representation of a particular screen of information with a user-session, the user-session identified with a particular task being performed by a user, wherein the particular screen of information of a particular user-session automatically displays data related to the particular user-session.

19. The medium of claim 18, wherein the particular screen of information is a middle screen of information.

20. The medium of claim 18, wherein the at least one selectable navigational control is presented as a selectable option in a menu box, the menu box being organized by subject matter.
